(19) United States
(12) Patent Application Publication
(10) Pub. No.: US 2016/0267798 A1
(43) Pub. Date: Sep. 15, 2016

(54) SYSTEM, DEVICE, AND METHOD TO DEVELOP HUMAN CHARACTERISTICS AND BRAIN TRAINING WITH SPECIALIZED COMPUTER-BASED APPLICATIONS

(71) Applicant: Cento e Vinte 120 Participaçoes e Empreendimentos Ltda., Sao Paulo (BR)

(72) Inventor: Albert Holzhacker, Sao Paulo (BR)

(21) Appl. No.: 14/644,093

(22) Filed: Mar. 10, 2015

(51) Int. Cl. G09B 5/02

(52) U.S. Cl. CPC G09B 5/02

(57) ABSTRACT

A human characteristic development and brain training system includes a processor configured to operate an application configured to display a user interface, generate an entry that include information about a life event experienced by the user, store the entry from the user in a database stored in the memory, present a list of strengths to the user through the user interface for the user to select from, assign at least one strength to the entry as being associated with the life event, and celebrate progress associated with strengths. A related method includes managing a database of entries including information about at least one life event of a user, associating at least one life event with at least one strength of the user, and linking a plurality of entries together in a group for the user to view and celebrate micro-progresses in behavior for similar life events.

### TECHNICAL FIELD

Embodiments of the present disclosure relate generally to the mobile application industry, and in particular, systems, devices, and methods for developing human characteristics utilizing specialized computer-based applications.

### BACKGROUND

The human brain has an outstanding richness and complexity. The human brain includes an estimated 86B+ neurons that, if stretched out, would extend over 1M miles. Each neuron has roughly 10,000 synapses having variable forms and sizes, which connect neurons to form a connectome for the individual. The human brain exhibits neuroplasticity, in that this connectome changes over time. For example, neurons can develop new branches, as well as lose old branches. Synapses can be created, eliminated, and grow larger or smaller. This neuroplasticity is a lifelong endeavor, and brain activity can shape the brain even at advanced ages.

Nobel Prize-winning psychologists Daniel Kahnemann and Amos Tversky discovered that the brain is composed of two systems. They call these two systems simply “system 1” and “system 2.” System 1 is described as the “fast” brain, and has the characteristic of working fast, being more emotional, being more automatic, desires instant gratification, and does not need much energy to operate. System 2 is described as being the “slow” brain, and has the characteristics of being logical and rational, working slower, making plans for the future, and uses a lot of energy for self-regulation. Therefore, most of our fast and low energy consuming responses come from System 1, whereas the slow and high energy consuming responses come from system 2. The inventor has appreciated a need for a system and method for sculpturing and training the brain and developing human characteristics according to embodiments of the disclosure herein.

### SUMMARY

A human characteristic development and brain training system comprises a processor operably coupled with an electronic display and a memory. The processor is configured to operate an application configured to display a user interface to the electronic display for receiving inputs from a user, generate an entry that include information about a life event experienced by the user, store the entry from the user in a database stored in the memory, present a list of strengths to the user through the user interface for the user to select from, and assign at least one strength to the entry as being associated with the life event.

A method of operating a human character training system is disclosed. The method comprises managing a database of entries from at least one user, the entries including information about at least one life event of the at least one user, associating the at least one life event with at least one strength of the user, and linking a plurality of entries together in a group for the user to view micro-progresses in behavior for similar life events.

### BRIEF DESCRIPTION OF THE DRAWINGS

FIG. 1 is a simplified block diagram of an example of a user device of a human character training system according to an embodiment of the present disclosure.

FIG. 2 is a flowchart illustrating a method of operating a human character training system according to an embodiment of the present disclosure.

FIGS. 3 through 15 show various screenshots displayed by a user device while implementing the method illustrated by the flowchart of FIG. 2.

FIG. 16 is a flow diagram showing a method for generating a focus list according to an embodiment of the present disclosure.

FIGS. 17 through 19 show various screenshots displayed by a user device while implementing the method illustrated by the flowchart of FIG. 16.

FIGS. 20 through 23 are screenshots displayed by a user device for visual displays showing user character strengths in the aggregate over a period of time according to embodiments of the present disclosure.

### DETAILED DESCRIPTION

In the following detailed description, reference is made to the accompanying drawings which form a part hereof and, in which are shown by way of illustration, specific embodiments in which the invention may be practiced. These embodiments are described in sufficient detail to enable those of ordinary skill in the art to practice the invention, and it is to be understood that other embodiments may be utilized, and that structural, logical, and electrical changes may be made within the scope of the disclosure.

In this description, specific implementations are shown and described only as examples and should not be construed as the only way to implement the present invention unless specified otherwise herein. It will be readily apparent to one of ordinary skill in the art that the various embodiments of the present disclosure may be practiced by numerous other partitioning solutions. For the most part, details concerning timing considerations and the like have been omitted where such details are not necessary to obtain a complete understanding of the present disclosure and are within the abilities of persons of ordinary skill in the relevant art.

Referring in general to the following description and accompanying drawings, various embodiments of the present disclosure are illustrated to show its structure and method of operation. Common elements of the illustrated embodiments may be designated with similar reference numerals. It should be understood that the figures presented are not meant to be illustrative of actual views of any particular portion of the actual structure or method, but are merely idealized representations employed to more clearly and fully depict the present invention defined by the claims below.

It should be further appreciated and understood that the various illustrative logical blocks, modules, circuits, and algorithm acts described in connection with embodiments disclosed herein may be implemented as electronic hardware, computer software, or combinations of both. To clearly illustrate this interchangeability of hardware and software, various illustrative components, blocks, modules, circuits, and steps are described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the embodiments of the disclosure described herein.

The various illustrative logical blocks, modules, and circuits described in connection with the embodiments disclosed herein may be implemented or performed with a general purpose processor, a special purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Embodiments of the present disclosure include a human character training system and related method that enable a user to record, monitor, and analyze their own behavior as well as the behavior of others to help the user track improvements (i.e., small wins) over time. The improvements may be celebrated by the user. As a result of engaging in the method, the user may be transformed into an improved individual. In particular, the user's brain may be trained and sculptured by tracking small improvements in behavior wins (i.e., steps) anywhere, anytime, and during the user's normal daily life/activities. In particular, the system may draw the user's attention to the user's small wins that are recorded by the system, which can then be reviewed and celebrated at a later time as improvements are made. The user may be enabled to include a particular character strength that was used in accomplishing the small win. The user may also be enabled to categorize each entry as part of a longer range of focus and/or as a particular adversity or challenge the user faces. Such a process of sculpturing and behavior training may be adaptive and continuous throughout the life of the user, which may enable the user to better adapt, learn, and improve behavior and character for mental, emotional, physical, and spiritual endeavors.

Such embodiments may find support in modern neuroscience research indicating a lifelong neuroplasticity of the brain. As a result, the brain can be shaped with practice and repetition, repetition, repetition. Modern research also indicates that neurons that fire together wire together—meaning that the neurons establish more synapses and larger synapses where there is greater activity and greater repetition. In the concept of the two system brain, it is understood that system 2 of the brain trains system 1 of the brain. These two systems are also very different in how they learn. For example, while system 1 understands and responds to language, system 1 learns by repetitive experience, shock, or trauma. System 2, on the other hand, does learn from language. Embodiments of the present disclosure assist in this training process by providing a system and method for the user to practice repetition in improving their actions in their daily lives, while also recognizing small improvements over time to celebrate. Thus, it is believed that the synaptic connections involved in performing such a task may be enhanced. Additionally, it is believed that additional enhancements may occur by the user being aware of strengths and other motivations that are involved in their daily activities.

As a result, users may generate sensory experimented progresses, name a strength used, and celebrate the progress, which promotes increasing their use of strengths. Like with physical exercise, such repetition may help users of the system to develop their human characteristics and train their brain through mental exercises.

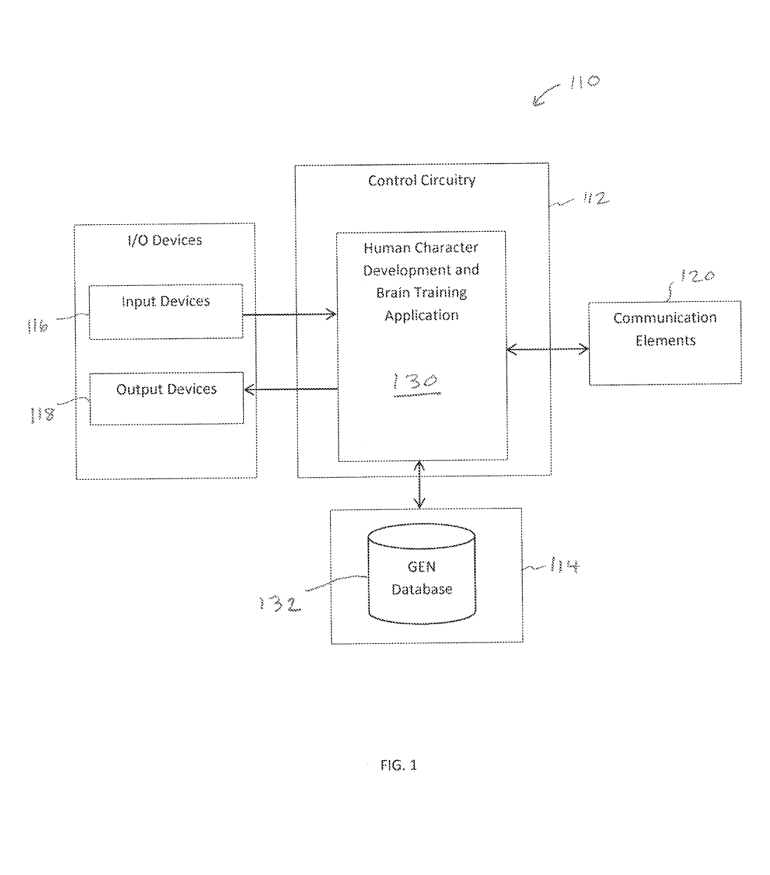

FIG. 1 is a simplified block diagram of a user device 110 of a human characteristic development and brain training system according to an embodiment of the present disclosure. The user device 110 may include control circuitry 112 operably coupled to one or more storage devices 114 (hereinafter referred to as storage device), I/O devices (input devices 116, output devices 118) configured to enable user interactions with the user device 110, and communication elements 120 configured to enable the user device 110 to communicate over networks with other devices (e.g., servers, other user devices, etc.). Networks may include a local area network (LAN), a wide-area network (WAN), the Internet, mobile wireless networks, other suitable networks, or combinations thereof.

The control circuitry 112 may include a memory device and a processor. The control circuitry 112 may be configured to execute an operating system. By way of non-limiting example, the operating system may include Android, iOS, Windows Phone, Microsoft Windows, Apple OS X, Unix, Linux, and other operating systems. The control circuitry 112 may include various application programs (hereinafter “apps”) configured to function in an environment provided by the operating system. For example, the control circuitry 112 may include a human characteristic development and brain training application 130 (hereinafter “training application” 130), which may be executed by the processor according to computer-readable instructions stored in memory of the storage device 114. In other words, the computer-readable instructions may be configured to instruct the control circuitry 112 to perform the functions discussed in more detail below. The computer-readable instructions may be provided to the user device 110 via a software distribution server having the computer-readable instructions stored thereon.

The input devices 116 may be configured to enable a user to interact with an interface of the training application 130, such as to provide inputs (e.g., text inputs, video inputs, audio inputs, etc.) into the system. For example, the input devices 116 may include a keyboard, microphone, camera, etc. Output devices 118 may be configured to convey information to the user from the training application 130, such as to provide outputs (e.g., text outputs, video outputs, audio outputs, etc.) from the system. For example, the output devices 118 may include electronic displays, speakers, etc. In some embodiments, some aspects of input devices 116 and output devices 118 may be integrally formed (e.g., touch screen display).

The storage device 114 may include a GEN database 132 stored in memory thereof. The GEN database 132 may include the recorded GEN entries and related data that are generated by the user during use of the training application 130. GENs will be discussed in more detail below.

The user device 110 may include smart phones, tablet computers, handheld computers, laptop computers, desktop computers, smart televisions, and other similar devices configured to deliver content to a user. While discussion herein is primarily focused on embodiments that include an “app,” it is contemplated that web-based embodiments that are accessible by web-browsers or other similar user interfaces are also within the scope of the present disclosure. Thus, rather than having the training application 130 stored locally on the user device 110, the training application 130 may be stored on a remote server that is accessed by the user device 110. The GEN database 132 may be maintained by the remote server in such an embodiment, which may also maintain the GEN databases for a plurality of different user devices. In some embodiments, at least a portion of the GEN database 130 may be stored both locally on the user device 110 with some data also being stored remotely.

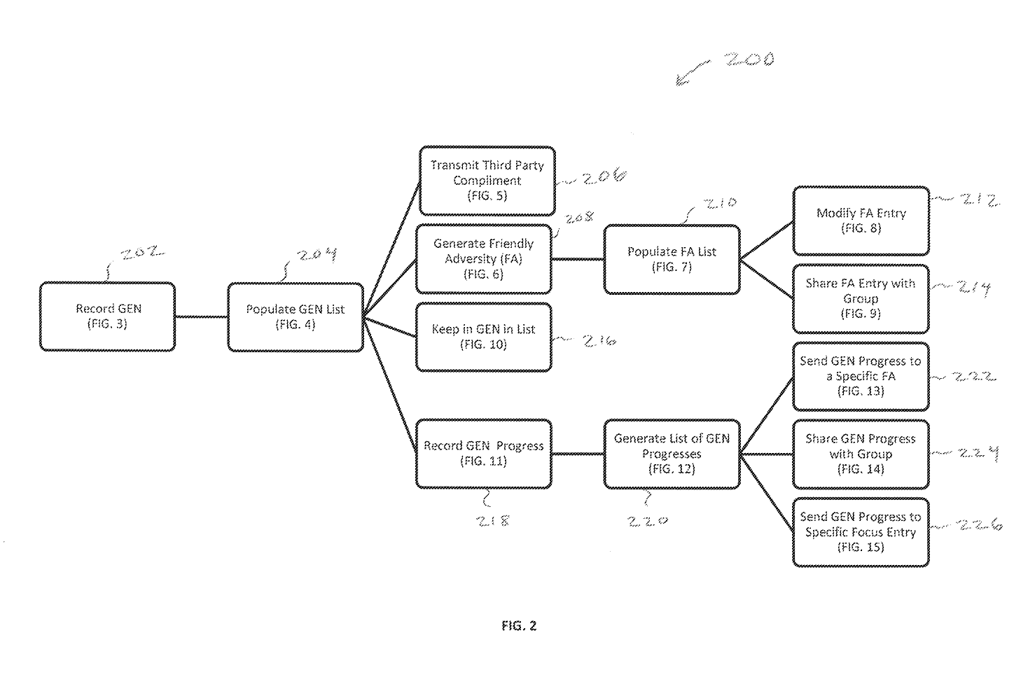

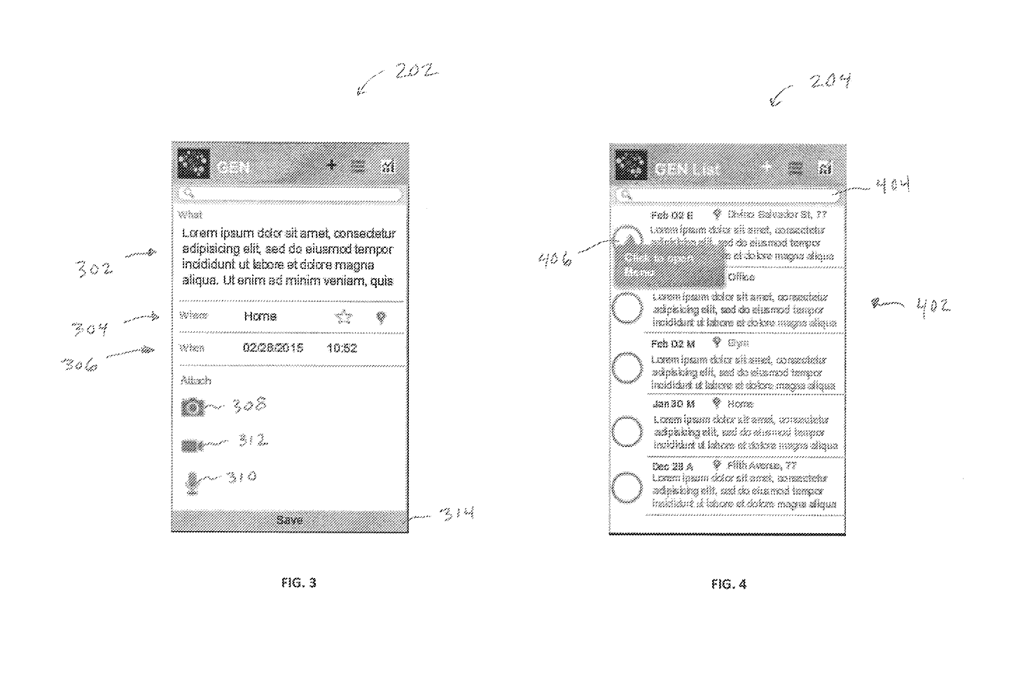

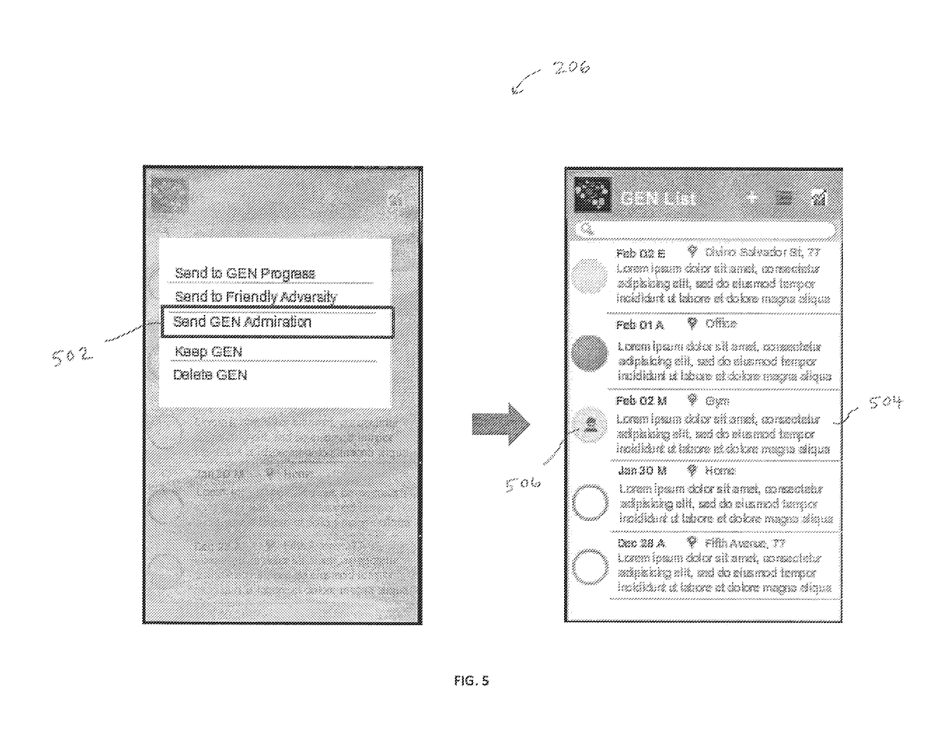

FIG. 2 is a flowchart 200 illustrating a method of operating a human characteristic development and brain training system according to an embodiment of the present disclosure. The method may be referred to as the “Geniantis” method. FIGS. 3 through 15 are screenshots of one or more interfaces that the user may interact with to input, analyze, and view information while interacting with the system. Throughout the description of the flowchart 200, the various screenshots are also discussed along with their corresponding operation from FIG. 2. In general, reference numerals having the nomenclature of 2xx, 3xx, 4xx, etc. will also correspond to FIG. 2, FIG. 3, FIG. 4, etc., respectively.

At operation 202, the user may record an entry (referred to herein as a “GEN” which is an abbreviation for Geniantis). As an example, the user may interact with an interface to input the information used to create the GEN. For example, each GEN may include information, such as “what,” “where,” and “when.” For example, the user may input text into the input field 302 to input information regarding the content (i.e., “what”) of the GEN, the user may input text into the input field 304 to input information regarding the location (i.e., “where”) of the GEN, and the user may input text into the input field 306 to input information regarding the time (i.e., “when”) that the GEN was created.

The content information of a GEN may include a description of something that the user has observed, a description of a situation (e.g., observation, interaction with another person, statement of fact, etc.) encountered by the user, a description of a problem (e.g., adversity, challenge, etc.) encountered by the user, a specific progress (e.g., “win”) that the user experienced, a specific progress that the user saw a third party doing that the user wants to compliment (e.g., “admire”), or a description of some other event that occurred in the user's life that the user would like to improve upon and/or learn from. The location information may include information about where the event occurred. The time information may include information about when the event occurred. At least some of this information may be automatically generated by the human characteristic development and brain training system. For example, the location information may be automatically retrieved according to the geolocation (e.g., using GPS data) of the user device. In addition, the time information may be automatically retrieved according to the internal time that is kept by the user device. Of course, the user device may enable the user to manually override the location and/or time information that is retrieved, which may be useful in the event that the user is creating a GEN for an event that occurred previously, for which a GEN had not been created at that time.

The content information of the GEN may be stored in the form of text, audio, an image, a video, or combinations thereof. For example, the user may input text into the input field 302 being displayed by the interface, which may provide an area for the user to type the content information therein. An image icon 308 may be selected if the user desires to attach a digital image file to the GEN being created. An audio icon 310 may be selected if the user desires to attach an audio file (e.g., voice memo) to the GEN being created. A video icon 312 may be selected if the user desires to attach a video file to the GEN being created. Selecting one of the icons 308, 310, 312 may enable the user to generate the respective file while also creating the GEN. In some embodiments, the respective file may have been generated previously and the user may retrieve the respective file from the storage of the user device. Thus, a GEN may include a variety of different types of data in various forms.

Once the user has input the information, the user may select the save icon 314 to save the GEN, which is stored in the GEN database for further review and evaluation by the user. For example, the user may have input a particular adversity or challenge the user faced, which may be reviewed at a later time to develop the “small win” that the user can execute in order to start solving the adversity/challenge. Once the GEN is recorded, additional operations may be available to the user with regard to the recorded GEN. Throughout the day, the user may generate additional GENs that are added to the GEN database.

In addition to manual entry of GENs into the GEN database, GENs may be generated automatically by the system without user involvement. For example, the processor may operate according to a set of rules to generate a GEN according to a triggering event. For example, the processor may be configured to communicate with external devices to receive information that may be converted into a GEN. In some embodiments, the rules may be configured to recognize progress such that the GEN may also be automatically categorized as a GEN progress. In some embodiments, the processor may require user authorization before adding to a GEN list, Progress list, or other list maintained by the system. In such an embodiment, a queue of GENS awaiting approval may be generated that must be approved before being added to a particular list.

As one example, the processor of the system may communicate with a scale such that when the user weighs himself, the processor may automatically generate a GEN and store it into the GEN database. Additional rules may include generating a GEN only responsive to certain weights being measured, progress made, or goals achieved. Additional health related GENs that may be automatically generated may include measurements of body mass index (BMI), blood pressure, cholesterol exams and other medical tests, or other situations in which a medical device or computer has health related information that may be desirable to monitor progress and celebrate. In other example, the processor of the system may communicate with exercise equipment (e.g., treadmills, steppers, stationary bikes, etc.) at a gym facility to obtain information that may be converted to a GEN.

In some embodiments, the system may communicate with other applications within the user's device to obtain information for automatically generating a GEN entry. For example, some applications may track a user's health data, such as monitoring the number of steps walked in a day, calories burned, calorie intake, heart rate, running/biking distance, hours slept, etc. Other types of applications may also have useful information for the GEN process, such as money management applications that track money spent and/or saved. The system may receive such data from other applications to automatically generate a GEN. Of course, the system's own application may be configured to monitor such activities on its own without needing to retrieve the data from other applications.

Additional features may include employing locational features (e.g., GPS) of the user's device to automatically generate GENS. For example, certain locations may be stored into the rules such that detecting the user's presence at that location may automatically generate a GEN. For example, the GPS location of the user's gym may be stored such that a GEN is automatically generated whenever the user attends the gym (or after a number of times attending the gym).

In addition, the system's application may also integrate with other applications on the user's device in order to receive status updates that may be converted into a GEN For example, a user may post updates to applications such as Facebook, Twitter, Instagram, etc. Such updates may occasionally have information that is suitable for a GEN. Thus, the user may also authorize certain posts to be stored as a GEN in addition to posting to that application so that the user does not have to make separate entries.

At operation 204, a GEN list 402 (FIG. 4) may be populated. The GEN list 402 may include a list of the recorded GEN entries, which may show at least some of the information of the GEN. For example, the time information may be shown for the GENs in the GEN list 402. In addition, at least a portion of the content information may be shown for each GEN of the GEN list 402. Each GEN entry may also include an icon 406, which the user may select to open a menu for performing additional actions regarding that GEN.

The icon 406 may also be used to provide information regarding the characterization and/or actions that have been taken regarding that particular GEN as will be discussed further below. As a non-limiting example, a red icon may indicate that particular GEN is a friendly adversity, a blue icon indicates that the GEN is an interesting observation that should be kept in the GEN list, a yellow icon indicates that the GEN is in the user's GEN progress list. An icon with a human head inside indicates that the GEN is an admiration that was sent to a third party. Of course, the particular method of indication is not limited to the color or icon scheme described herein, and other methods are also contemplated.

In some embodiments, the location information may be shown for the GENs in the GEN list 402. As more and more GENs are recorded, the GEN list 402 may increase and the user may be able to scroll through the GENs to find a particular GEN. The user interface may further include a search field 404 may enable the user to type in key words or other contextual searching methods that may correspond to the information stored in the GENs to help the user find GENs.

In some embodiments, other features may be available for the user to sort or otherwise manipulate the GENs in the GEN list 402. For example, the interface may further include a filter field (not shown) that the user can use to filter GENs according to common attributes. For example, GENs may be filtered according to how a GEN is categorized (e.g., friendly adversity, progress, focus, etc.) or as containing particular characteristics (e.g., hungers, strengths, etc.). GENs may also be filtered according to a particular date or date range or by other common attributes of the GENs.

By selecting a GEN from the GEN list 402, the user may view a list of options for actions that the user may take with regard to the selected GEN. Selectable actions may include providing the GEN to a progress list, providing the GEN to a friendly adversity list, sending the GEN to a third party, sharing the GEN with a group, and deleting a GEN. Each of these selectable actions will be discuss in more detail below.

At operation 206, the user may interact with the interface to select the action (sending a GEN admiration to a third party) as outlined by box 502 (FIG. 5). As a result, the interface may open a messaging interface configured to send the selected GEN to another individual. For example, the content information of the GEN may be applicable to a particular person. As an example, the user may have created a GEN based on an observation of the third party individual that the user would like to recognize. Thus, the new messaging interface may be opened to transmit the third party individual. The messaging interface may provide an interface whereby the user may transmit the GEN as well as an additional message to the third party individual. The additional message may provide additional context for the GEN (e.g., more information about the GEN, strengths associated with the GEN that were demonstrated by the, praise of the third party individual, etc.

For example, the user may send the following message to a third party: “congratulations for the use of the perspective strength in putting focus in the transition of students between the 5^{th} and the 6^{th} grade during the meeting held September 18 at the school district. This will help the whole school.” The third party may be entered into the messaging interface and/or retrieved from stored information (e.g., contact list) of the human characteristic development and brain training system.

In some embodiments, the information from the GEN may be automatically input into the body of the message to be sent to the third party individual. In some embodiments, the GEN itself may be attached to the message, and the user may be able to enter their own message to accompany the attached GEN. Of course, it is contemplated that the information of the GEN may be automatically input into the body of the message to be sent, as well as the messaging interface being configured to permit the user to enter additional information into the message. It is also contemplated that at least some of the information automatically inserted into the messaging interface may come from a template message that is selected by the user.

In some embodiments, the GEN may be sent to the third party individual via text message (e.g., SMS), email, or other forms of messaging. In some embodiments, if the third party has the human characteristic development and brain training system application stored on their user device, the GEN may be sent directly between the two applications. In such an embodiment, the GEN may be stored in the GEN list of the third party's application when it is received by the third party.

Upon completion of sending the GEN admiration to the third party the icon 506 associated with the corresponding GEN entry 504 may be transformed to indicate that a GEN admiration was sent for that particular GEN entry 504.

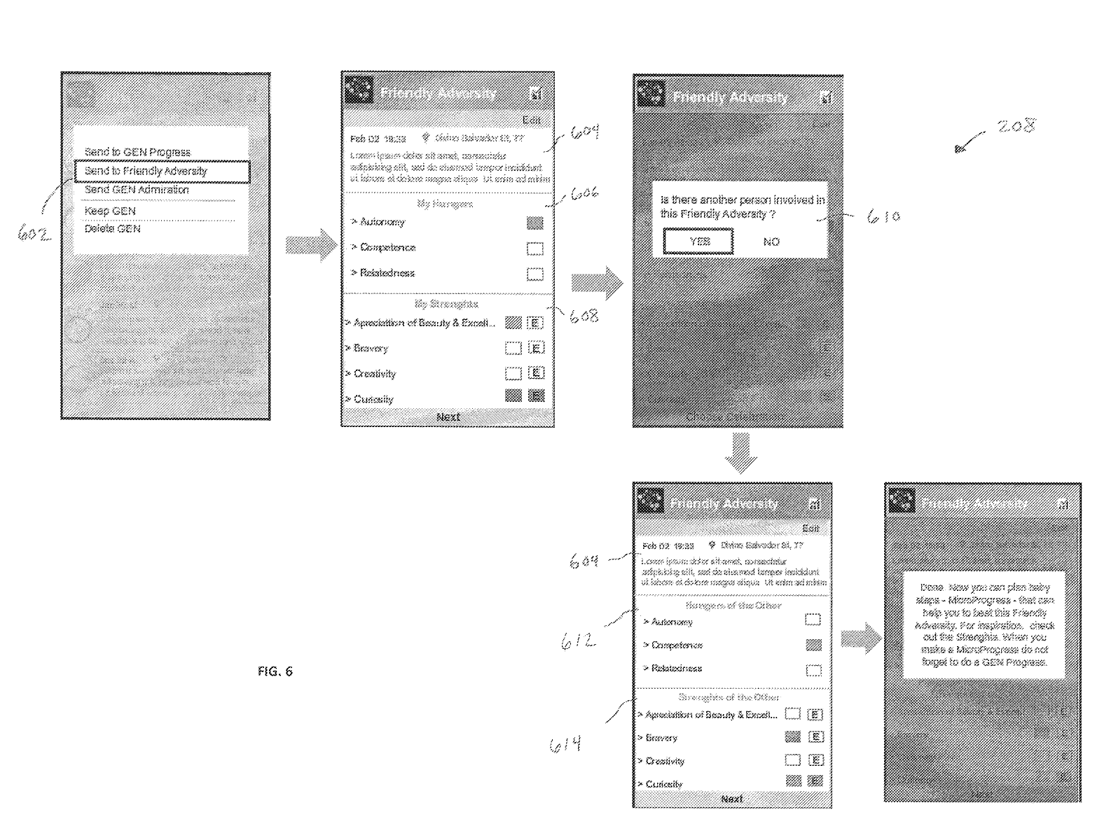

At operation 208, the user may interact with the interface to select the action (i.e., recording the GEN to be a friendly adversity) as outlined by box 602 (FIG. 6). Friendly adversities may be problems or challenges that the user faces, such as in the relationships (e.g., family, friends, coworkers, etc.) the user has. The system may provide a framework to assist the user in self-analyzing the situation, and then develop a strategic method to work on this problem.

Responsive to the user selecting the GEN to be a friendly adversity, the interface may provide additional options to help the user self-analyze (e.g., decompose) the underlying situation recorded by the GEN 604. The interface may be configured to present the user with a list of hungers 606 and a list of strengths 608 that may have been involved in the GEN from the perspective of the user. Hungers may be viewed as motivations of the user, whereas strengths may be viewed as tools that the user draws from. Hungers may be a grouped according to different intrinsic motivations that the user may have had in the way that they acted in that given situation. Three basic hungers include autonomy, competence, and relatedness as three intrinsic motivations for behavior. Thus, the system causes the user to assess how the user acted in this situation, and select what hungers were involved in influencing their behavior. Strengths refer to the attributes of the user that the user used in dealing with the situation. Strengths may include cognitive strengths (e.g., creativity, curiosity, judgment, love of learning, perspective), emotional strengths (e.g., bravery, perseverance, honesty, zest), humanity strengths (e.g., love, kindness, social intelligence), justice strengths (e.g., teamwork, fairness, leadership), temperance strengths (e.g., forgiveness, humility, prudence, self-control), transcendence strengths (e.g., appreciation of beauty and excellence, gratitude, hope, humor, spirituality). Studies indicate that individuals with a high level of efficient use of these strengths would be much better prepared physically, materially, mentally and spiritually for the geographical (e.g., local and remote) as well as temporal threats and opportunities of life. Other strengths are also contemplated, including those identified by the Gallup organization. While the list of strengths 608 only shows four strengths (e.g., appreciation of beauty and excellence, bravery, creativity, curiosity), this is because the list of strengths may be long and may exceed the space shown for the interface. It should be appreciated that the user may scroll down to view other strengths to select from.

As shown in FIG. 6, the user has selected “autonomy” from the list of hungers 606 as influencing their behavior in the situation for this particular GEN, and “love” from the list of strengths 608 as the attribute they used in the situation. The interface may provide the user with two options for selection when assessing their strengths. The option labeled “E” may indicate that the particular strength was “excessive,” which may have led to a problem even though a strength may typically be seen as making positive impacts.

The interface may also ask the user if there is another person involved in this friendly adversity (option 610). If the user selects “yes,” the interface may display a similar list of hungers 612 and list of strengths 614 for the user to select from the perspective of the other individual. In other words, the user may assess the motivations (hungers) and attributes (strengths) of the other person involved in the situation of the underlying GEN. As shown in FIG. 6, the user has selected “competence” as the other person's hunger in this situation, and bravery and curiosity as strengths. Thus, by using the system, the user may have identified one reason for the conflict was because of the different hungers each individual was trying to satisfy. The user was trying to satisfy their need for autonomy, whereas the other individual was trying to satisfy the need for feeling competent. The user may also have identified that each of them have different strengths, but that some strength may have been excessive in this situation. The user may also think about what other strengths may have been desirable to have used in that situation. Thus, the user may have analyzed the situation in a way that can provide understanding and future improvements for dealing with similar situations in the future to decrease this particular adversity.

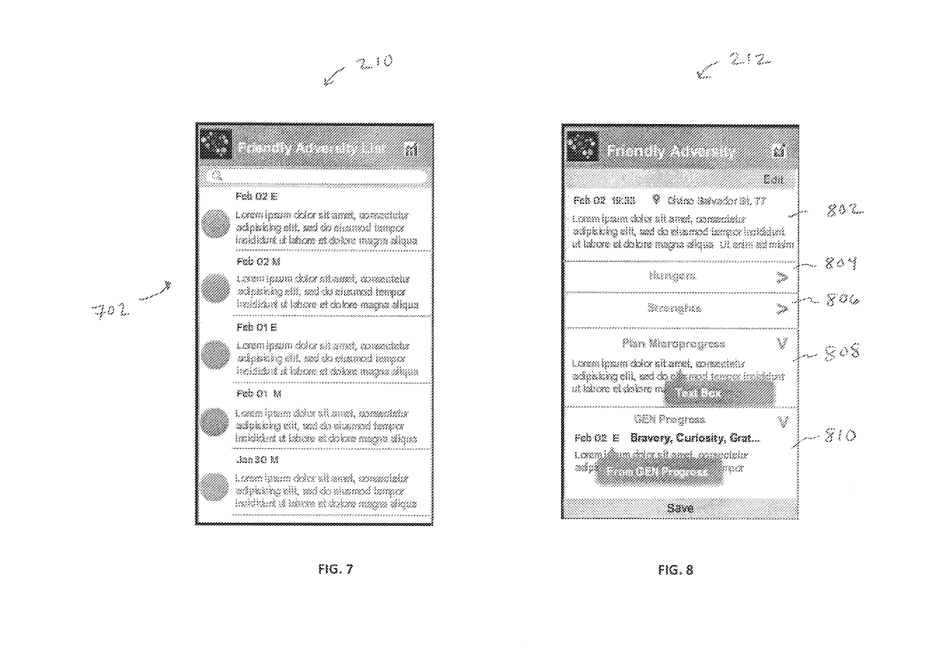

After completing selection of hungers and strengths for the user as well as others involved in the underlying situation of the GEN, the GENs that have been designated as “friendly adversities” may be populated in a list 702 (FIG. 7) of friendly adversities at operation 210. The user can review the GENs in this list 702 to recall past situations and their associated hungers and strengths. The user may select a GEN from this list 702, which may cause the interface to display additional options 804, 806, 808, 810 (FIG. 8) at operation 212 for reviewing the GEN 802. In particular, the user may view the hungers 804 and strengths 806 associated with the selected GEN for both the user and others. In addition, the user may create a plan 808 for measuring progress in this GEN. The plan 808 may be a description input by the user into a text field of the interface or through other methods. In addition, the user may link other GENs 810 or create new GENs that are related (e.g., involve similar situations, involve interactions with the same people, etc.) from the GEN progress list (discussed below). As a result, small progress may be achieved with subsequent entries to identify future progresses, which may motivate the user to solve and/or decrease the particular adversity.

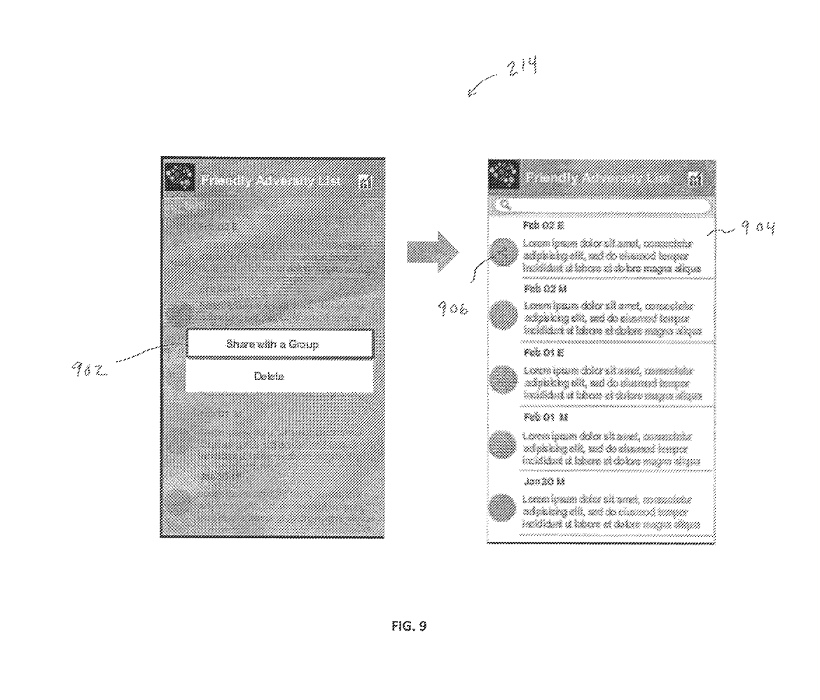

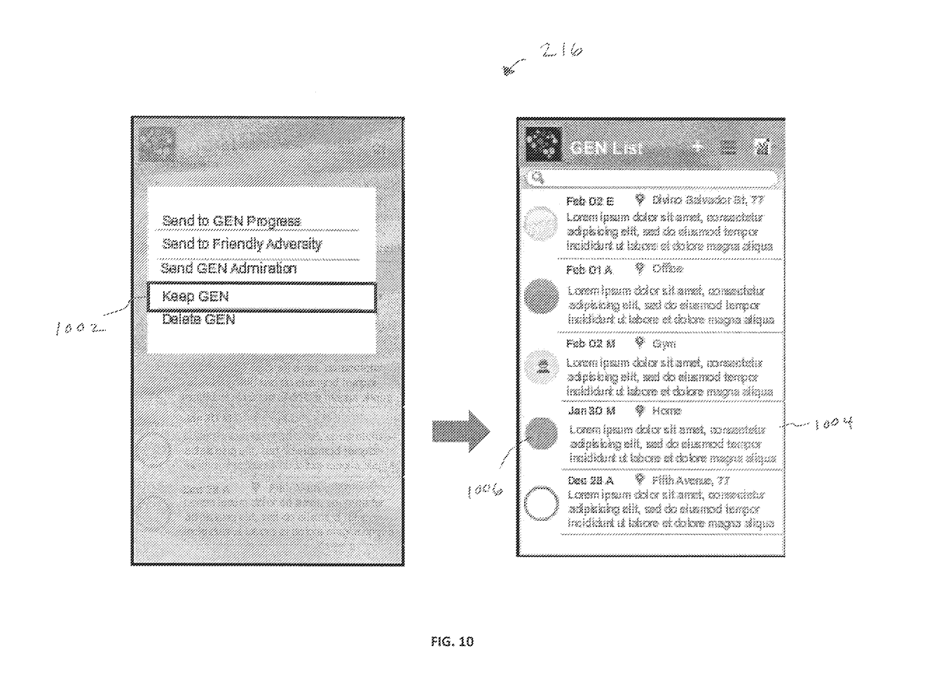

At operation 214, the user may select a friendly adversity entry 904 (FIG. 9) and share the friendly adversity entry with a group as indicated by selection 902. The icon 906 may include an additional icon indicating that the friendly adversity was also shared.

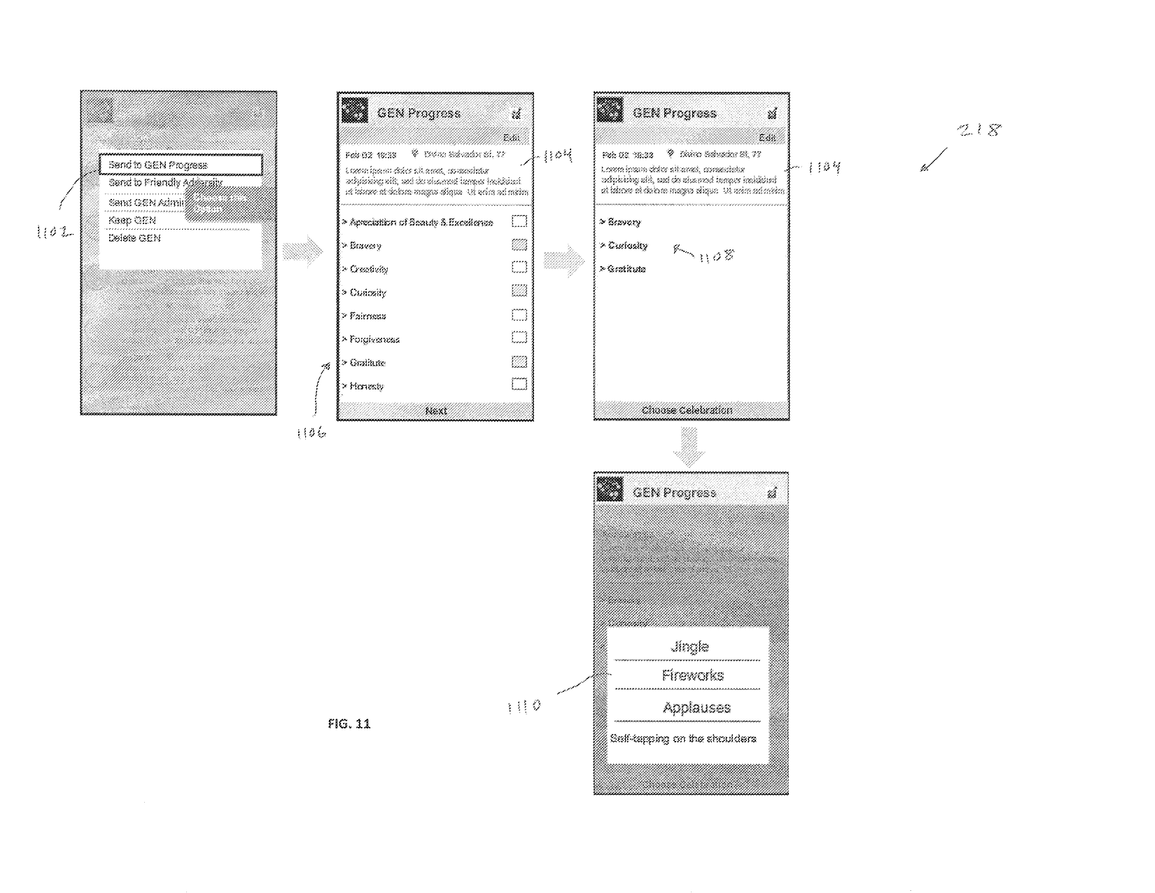

At operation 216, the user may select a GEN 1004 shown by box 1002 (FIG. 10) for the GEN 1004 to be kept in the GEN list as an observation of particular interest that the user may wish to highlight through the changed indication of icon 1006 for later review.

At operation 218, the user may generate a GEN progress entry for a selected GEN. From the GEN list, the user may interact with the interface to select the action (send to GEN progress) as outlined by box 1102 (FIG. 11). A GEN progress may provide the user with an opportunity to identify progress with regard to a particular strength that the user desires and celebrate the progresses made. For example, the selected GEN entry 1104 may identify a situation (e.g., the user avoided conflict at work). The user may select strength from the strength list 1106 to identify strengths used to achieve that progress. For example, as shown in FIG. 11 the user selected the strengths 1108 of bravery, curiosity, and gratitude. As a result, a progress entry for the GEN 1104 may be generated by associating strengths 1108 with the selected GEN 1104. The user may also choose to celebrate the progress that has been made. For example, a menu 1110 may be presented to the user to select from among a list of celebrations (e.g., jingle, fireworks, applause, self-tapping, etc.). As a result, by promoting a pattern of recording small, specific sensorial progresses (e.g., what, when, where) of an event, that are registered as a GEN, and then classified with character strengths that are individually named, and celebrated, the sensory stimulation of the user's brain may increase. In addition, revisiting these events with such specificity may result in higher activation in the same area as the original sensory stimulation, which may result in more accelerated and lasting development of the user's character strengths by training the connections and synapses of their brain.

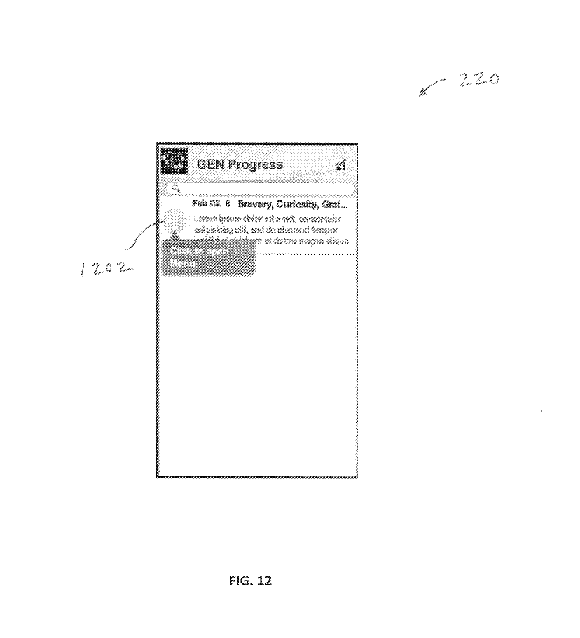

At operation 220, the user may wish to populate a GEN progress list (FIG. 12) to review each GEN that has been selected by the user to be a GEN progress entry. The user may utilize search fields 1204 as discussed above to find GENs and view portions of a large list based on some criteria (e.g., search terms, filter categories, etc.). The GEN progress list may be linked to other lists such as the friendly adversity list as well as focus lists discussed below. The user may select the icon 1202 to open a menu to provide additional options for the user to modify and/or link the GEN progress entry with other lists.

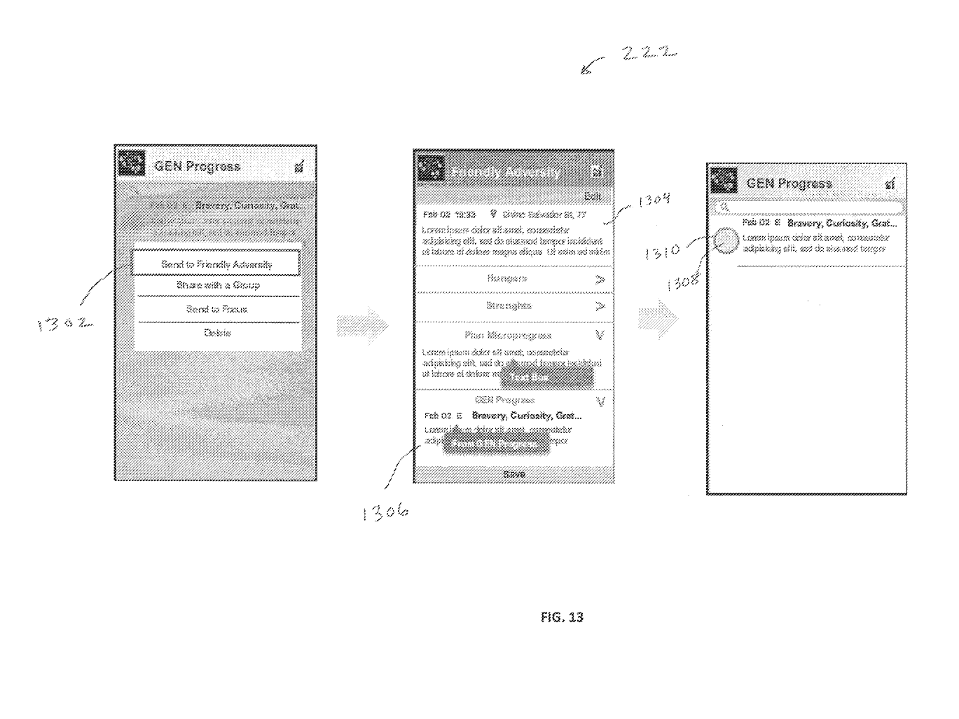

At operation 222, the user may send the GEN progress entry to a friendly adversity list to link the GEN progress entry to a particular friendly adversity entry. For example, the user may select the action (send progress to friendly adversity) as outlined by box 1302 (FIG. 13). The system may open an entry from the friendly adversity list that provides the option to add GEN progresses to the entry of the friendly adversity list that corresponds to the selected GEN entry. From the friendly adversity list, the user may operate in a similar manner as discussed above. As shown in FIG. 13, the GEN progress entry 1306 may appear in the list of information that is associated with a particular friendly adversity entry 1304. Thus, the user may be able to review the adversity, hungers, strengths, the micro-progress plan, and any progress that has been made and celebrated for this particular adversity. After a GEN has been linked to both a GEN progress as well as a friendly adversity, the GEN icon may have multiple indications 1308, 1310 for the user to see that there are multiple characterizations of that GEN.

At operation 224, the user may desire to share the GEN progress entry with a group. For example, the user may select the action (share with group) as outlined by box 1402 (FIG. 14). The GEN icon 1404 may change to reflect that the GEN progress has been shared with a group.

At operation 226, the user may send the GEN progress entry to a focus list. For example, the user may select the action (send to focus) as outlined by box 1502 (FIG. 15). The system may open an entry from the focus list that provides the option to add the GEN progress entry to a particular focus list. As shown in FIG. 15, a focus entry 1504 has been created with a focus goal of saving money. The GEN progress entry has been linked to the focus entry 1504 and appears in the information that is associated with that focus entry 1504. After a GEN progress entry has been linked to the focus entry 1504, the icon 1508 may be updated to indicate the additional characterizations of that GEN.

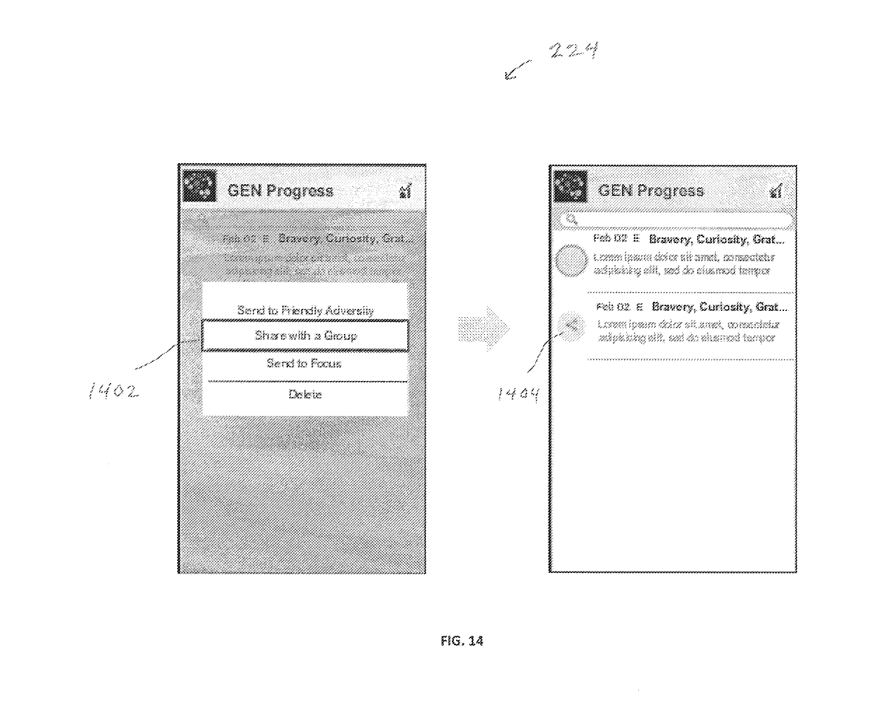

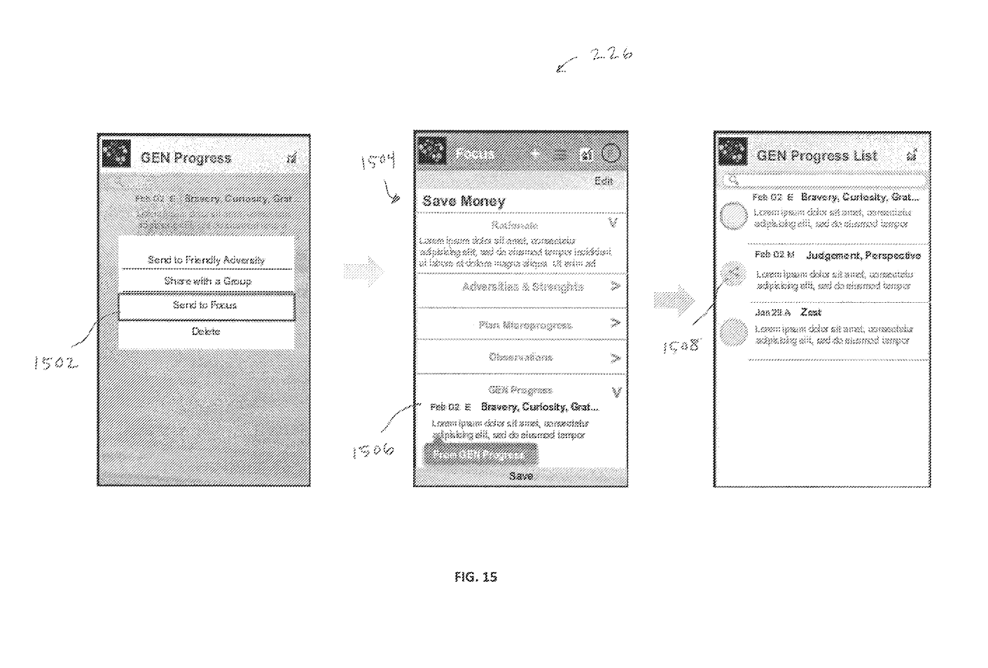

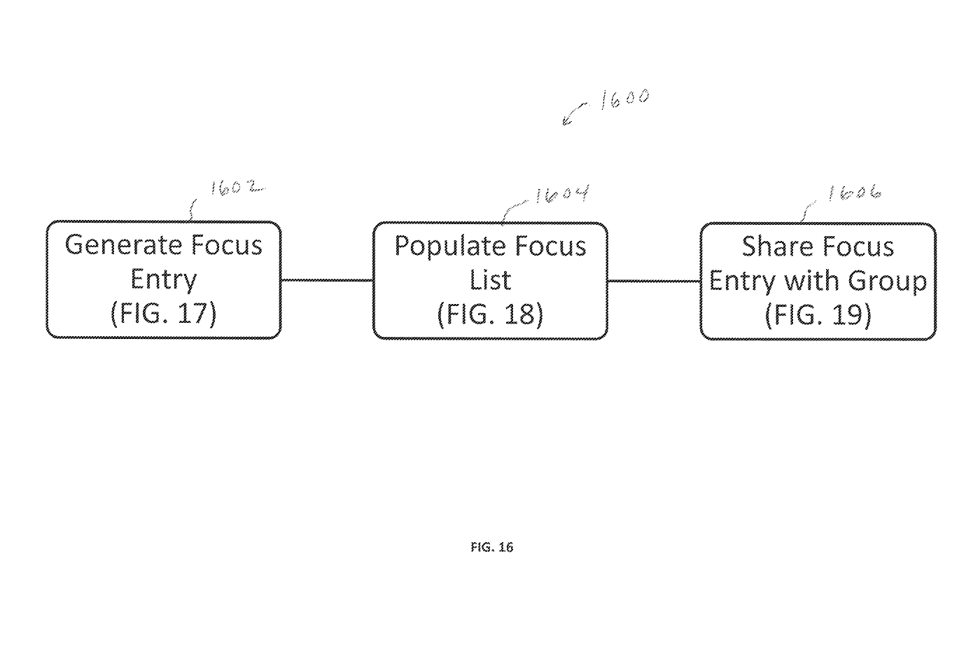

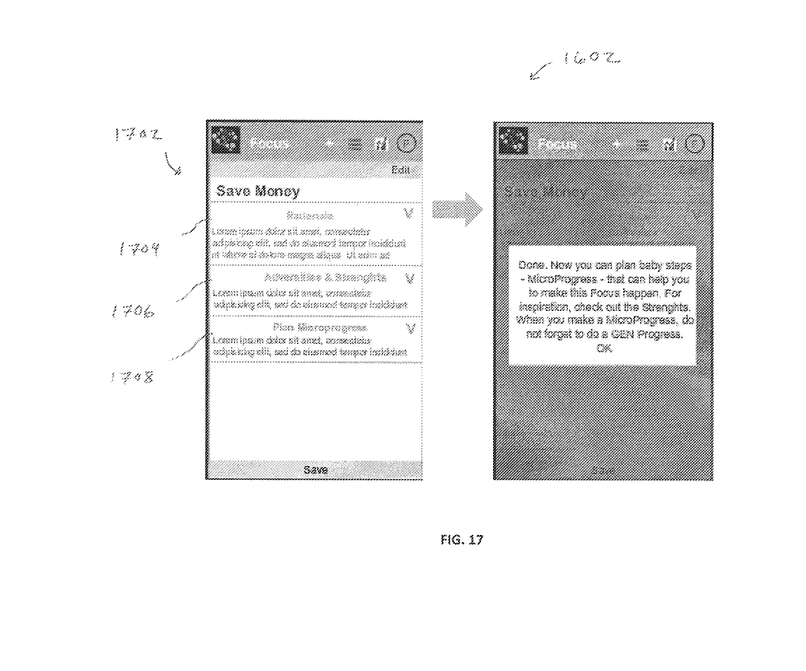

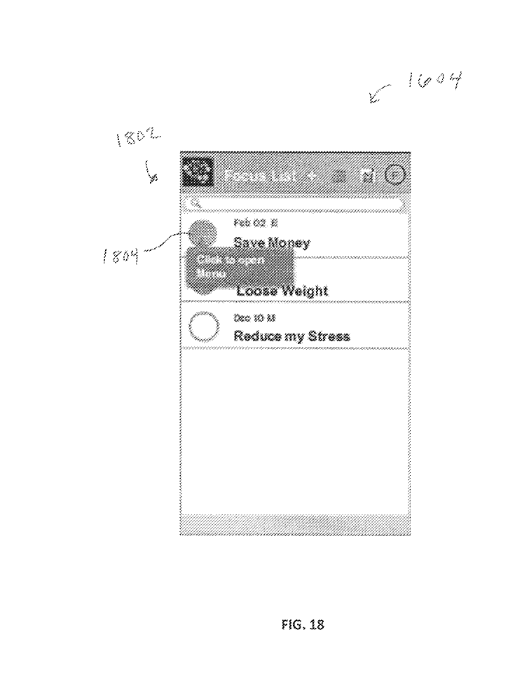

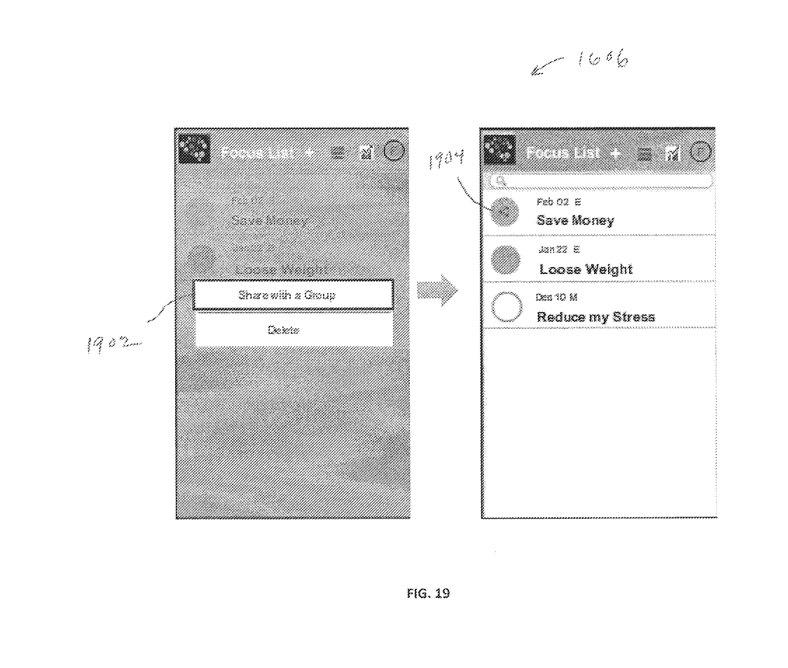

FIG. 16 is a flow diagram showing a method for generating a focus list according to an embodiment of the present disclosure. FIGS. 17 through 19 are screenshots of one or more interfaces that the user may interact with to input, analyze, and view information while interacting with the system. Throughout the description of the flowchart 1600, the various screenshots are also discussed along with their corresponding operation from FIG. 16.

FIG. 17 shows an example of a focus list 1702 that may be generated. Focus lists may provide the user the ability to define a particular focus area for improvement or goal setting. For example, perhaps the user desires to improve his money management habits. The user may use the focus list to create a plan for achieving a goal on that particular topic. The user can enter reasons (i.e., rationale 1704) why that goal would be important to the user to help define the goal, the user can enter possible difficulties and strengths 1706 that the user may encounter while making progress toward the focus goal, and the user may create a plan 1708 for different steps of progress to help achieve the focus goal. Once the focus list 1702 is created, the user may also link GENs to the focus list as observations and progresses that may fit within the focus topic. The user may wish to review this GEN list for the particular focus group. Throughout the process of measuring improvement (whether in the GEN progress list, friendly adversity list, and focus list), the user may recognize small improvements over prior behaviors. As a result, the user may enter into the system celebratory entries as positive reinforcement to encourage additional progress.

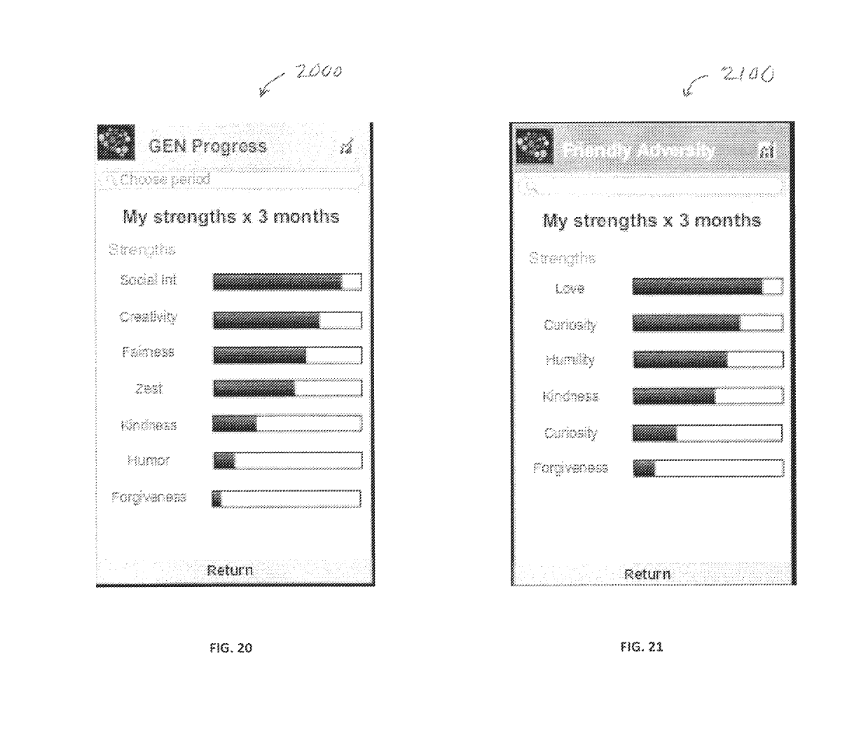

In some embodiments, the system may also include a visual display that shows how much the user uses their character strengths in the aggregate over a period of time. Thus, the processor may analyze the strengths identified in each of the GENs stored in the database to populate the visual display. The visual display may indicate the aggregate amount of use of each strength relative to each other in a single location. FIGS. 20 through 23 illustrate examples of such visual displays according to embodiments of the present disclosure. In addition, while the visual representations below aggregate the usage of a user's strengths, other information may also be aggregated and displayed for the user to review (e.g., hungers used in friendly adversities).

FIG. 20 is a screenshot 2000 showing a bar graph of the strengths used by the user according to the GEN progresses that are stored in the GEN database. In response to a user selecting a graph generation option within a GEN progress screen, the processor may analyze the different GEN progress entries to generate a bar graph showing the aggregated results for a defined period of time. FIG. 20 shows a defined period of time being the past three months; however, other time periods may also be defined. In addition, the processor may be configured to enable the user to select a customized date range. The strengths may be listed in a variety of different methods, such as according to a ranking from the most commonly used strength to the least commonly used strength as shown in FIG. 20. In other embodiments, the strengths may be listed from least common to most common if the user desires to view their least commonly used strengths at the top. Other listing (e.g., alphabetical) orders are also contemplated.

FIG. 21 is a screenshot 2100 showing a bar graph of the strengths used by the user according to the friendly adversity entries that are stored in the GEN database. As with the interface of FIG. 20, the strengths for the friendly adversity entries may be aggregated by the processor and displayed for a desired period of time, and listed in a variety of different orders and formats. Although FIGS. 20 and 21 do not show a similar graph for strengths used in focus groups, it is contemplated that such an graph is within an embodiment of the present disclosure.

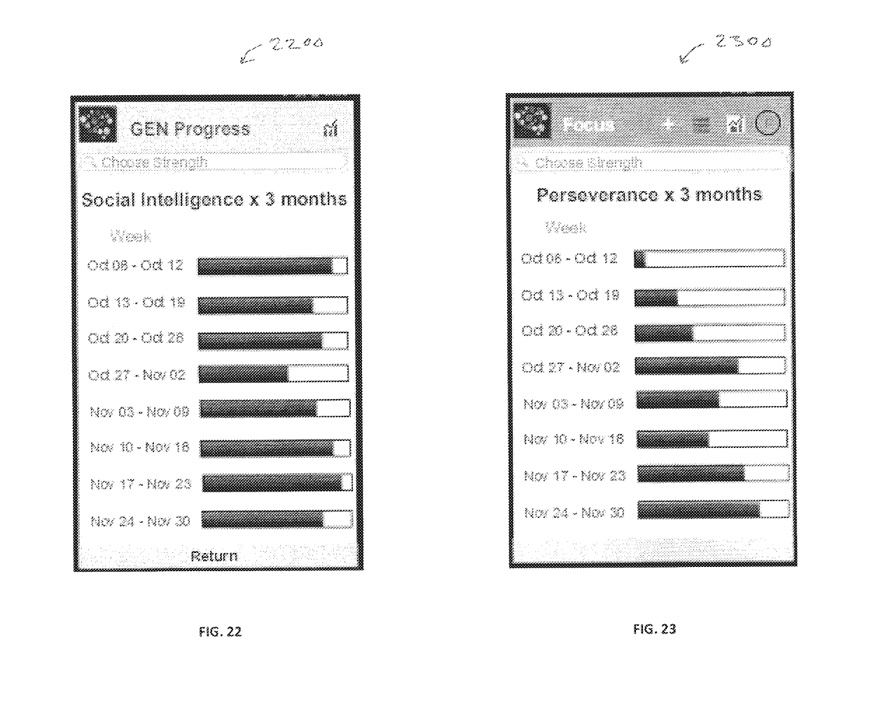

FIG. 22 is a screenshot 2200 showing another bar graph of an individual strength (e.g., social intelligence) used by the user in their GEN progress entries over a desired period of time (e.g., three months). The period of time may be broken down into smaller time periods (e.g., weeks) so that the user can visualize trends in the strengths used in the GEN progress entries. The user may enter this screen by selecting one of the individual strengths on the full list of strengths (e.g., selecting “social intelligence” on the bar graph in FIG. 20).

FIG. 23 is a screenshot 2300 showing another bar graph of an individual strength (e.g., perseverance) used by the user in their focus list entries over a desired period of time (e.g., three months). The period of time may be broken down into smaller time periods (e.g., weeks) so that the user can visualize trends in the strengths used in the GEN progress entries. The user may enter this screen by selecting one of the individual strengths on the full list of strengths (e.g., selecting “perseverance” on the bar graph in FIG. 21). Although FIGS. 22 and 23 do not show a similar graph for individual strengths used in friendly adversities, it is contemplated that such an graph is within an embodiment of the present disclosure.

Although the visual displays shown in FIGS. 20 through 23 are shown as a bar graph, other visual representations of the aggregate strength date is also contemplated. For example, the visual displays may include word clouds, bar graphs oriented vertically or horizontally, histograms, pie charts, and other types of visual reprentations.

While the disclosure is susceptible to various modifications and implementation in alternative forms, specific embodiments have been shown by way of non-limiting example in the drawings and have been described in detail herein. It should be understood that the disclosure is not intended to be limited to the particular forms disclosed. Rather, the disclosure includes all modifications, equivalents, and alternatives falling within the scope of the following appended claims and their legal equivalents.

What is claimed is:

1. A human characteristic development and brain training system, comprising:
a processor operably coupled with an electronic display and a memory, wherein the processor is configured to operate an application configured to:
display a user interface to the electronic display for receiving inputs from a user;
generate an entry that include information about a life event experienced by the user;
store the entry from the user in a database stored in the memory;
present a list of strengths to the user through the user interface for the user to select from; and
assign at least one strength to the entry as being associated with the life event.

2. The system of claim 1, wherein the entry includes content information, time information, and location information for the life event.

3. The system of claim 1, wherein the application is further configured categorize the entry as a progress entry that is celebrated by the application.

4. The system of claim 1, wherein the application is further configured to categorize the entry as a friendly adversity entry, and present a list of hungers to the user through the interface for the user to select from, and assign at least one hunger to the entry as being an intrinsic motivation of the user for the life event.

5. The system of claim 4, wherein the user interface for the friendly adversity entry includes a list of additional progress entries associated with successful life events related to the friendly adversity entry.

6. The system of claim 1, wherein the entry includes information about another person who was a participant to the life event.

7. The system of claim 6, wherein the application is further configured to:
present another list of strengths to the user through the user interface for the user to select from for the another person;
assign at least one strength to the entry as being associated with the life event for the another person;
present another list of hungers to the user through the interface for the user to select from, and
assign at least one hunger to the entry as being an intrinsic motivation of the another person for the life event.

8. The system of claim 1, wherein the application is further configured to generate a focus area defined by the user for focusing on a specific goal to work on.

9. The system of claim 1, wherein the processor is further configured to retrieve aggregate data regarding used strengths by the user, and display the aggregate data as a visual representation for a defined period of time.

10. The system of claim 1, wherein the entries include at least one additional image file, audio file, or video file associated with the life event.

11. The system of claim 1, further comprising a user device that includes the processor, the electronic display, and the memory.

12. A method of operating a human characteristic development and brain training system, the method comprising:
managing a database of entries from at least one user, the entries including information about at least one life event of the at least one user;
associating the at least one life event with at least one strength of the user;
categorizing an entry for the at least one life event as a progress entry that is celebrated through the system; and
displaying a plurality of entries together as a list for the user to view micro-progresses in behavior for similar life events.

13. The method of claim 12, wherein linking the plurality of entries together include linking at least two entries together for situations identified as a friendly adversity involving another person.

14. The method of claim 13, wherein associating the life event with at least one strength of the user includes associating at least one strength that the user identifies as being an excessive strength exhibited by the user during the life event.

15. The method of claim 14, further comprising associating the at least one life event with at least one strength of the another person.

16. The method of claim 15, further comprising associating the at least one life event with a hunger for each of the user and the another person, wherein the hunger indicates a motivation for the respective user and another person in their handling of the at least one life event.

17. The method of claim 12, further comprising generating an entry based on information related to the at least one life event.

18. The method of claim 17, wherein generating the entry is performed automatically by a processor responsive to a trigger defined by a predetermined rule.

19. The method of claim 12, further comprising associating a first entry with an area of focus interface displaying a focus area identified by the user for achieving a defined goal.

20. The method of claim 12, further comprising displaying an interface on a user device, the interface configured to provide a pre-defined list of strengths for the user to select for associating the strengths with the entry.
